(19) United States
(12) Patent Application Publication
(10) Pub. No.: US 2021/0073197 A1
(43) Pub. Date: Mar. 11, 2021

(54) BYZANTINE CONSENSUS WITHOUT CENTRALIZED ORDERING

(71) Applicant: Microsoft Technology Licensing, LLC, Redmond, WA (US)

(72) Inventors: Srinath SETTY, Redmond, WA (US); Qi CHEN, Beijing (CN); Lidong ZHOU, Bellevue, WA (US)

(21) Appl. No.: 16/563,580

(22) Filed: Sep. 6, 2019

(51) Int. Cl. G06F 16/23; G06F 9/46

(52) U.S. Cl. CPC G06F 16/2336; G06F 9/466

(57) ABSTRACT

Devices and methods for creating a totally ordered ledger of transaction may include assigning a ledger to the device, wherein the ledger includes transactions associated with a verifiable timestamp. The devices and methods may include providing a copy of the ledger to plurality of other devices in communication with the device. The devices and methods may include receiving copies of a plurality of other ledgers with other transactions associated with verifiable timestamps. The devices and methods may include generating an ordered ledger with an ordered list of transactions by performing a total order process that uses the verifiable timestamps of the transactions from the ledger and the verifiable timestamps of the other transactions from the copies of the plurality of other ledgers. The devices and methods may include executing the ordered list of transactions from the ordered ledger.

### BACKGROUND

The present disclosure relates to distributed systems.

A resurgent in Byzantine consensus protocols is occurring, especially for building consortium blockchains, where a set of mutually distrusting member nodes maintain an append-only ledger of committed records. Most prior Byzantine consensus protocols employ a special node acting as a leader to reach consensus on a series of proposed values in a certain order. Such a leader may have an unfair advantage in deciding what to propose and in what order. Such unfairness is undesirable in the context of consortium blockchains as participating members in those scenarios typically represent autonomous and distrusting organizations. Besides unfairness, such a leader is invariably susceptible to becoming a performance bottleneck limiting the throughput and latency in reaching agreement. Even worse, a faulty leader (unavailable or compromised) could introduce significant disruption to the service (e.g., a long period of unavailability with no progress in reaching agreement on new transactions) because the protocol has to wait for a new leader to be elected before it can proceed.

Thus, there is a need in the art for improvements in distributed systems.

### SUMMARY

The following presents a simplified summary of one or more implementations of the present disclosure in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations of the present disclosure in a simplified form as a prelude to the more detailed description that is presented later.

One example implementation relates to a device. The device may include a memory to store data and instructions, at least one processor configured to communicate with the memory, wherein the at least one processor generates a replicated state machine on the device, wherein the replicated state machine is configured to assign a ledger to the device, wherein the ledger includes transactions associated with a verifiable timestamp; provide a copy of the ledger to plurality of other devices in communication with the device, wherein the plurality of other devices each have replicated state machines; receive copies of a plurality of other ledgers with other transactions associated with verifiable timestamps from each of the replicated state machines of the plurality of other devices, wherein the plurality of other ledgers corresponds to a number of the plurality of other devices; generate an ordered ledger with an ordered list of transactions by performing a total order process that uses the verifiable timestamps of the transactions from the ledger and the verifiable timestamps of the other transactions from the copies of the plurality of other ledgers; and execute the ordered list of transactions from the ordered ledger.

Another example implementation relates to a method for creating a totally ordered ledger of transaction performed by a replicated state machine on a device with a memory and a processor. The method may include assigning, by the replicated state machine, a ledger to the device, wherein the ledger includes transactions associated with a verifiable timestamp. The method may include providing, via the replicated state machine, a copy of the ledger to plurality of other devices in communication with the device, wherein the plurality of other devices each have replicated state machines. The method may include receiving copies of a plurality of other ledgers with other transactions associated with verifiable timestamps from each of the replicated state machines of the plurality of other devices, wherein the plurality of other ledgers corresponds to a number of the plurality of other devices. The method may include generating, via the replicated state machine, an ordered ledger with an ordered list of transactions by performing a total order process that uses the verifiable timestamps of the transactions from the ledger and the verifiable timestamps of the other transactions from the copies of the plurality of other ledgers. The method may include executing, via the replicated state machine, the ordered list of transactions from the ordered ledger.

Another example implementation relates to computer-readable medium storing instructions executable by a computer device. The computer-readable medium may include at least one instruction for causing the computer device to assign a ledger to the computer device, wherein the computer device includes a replicated state machine and the ledger includes transactions associated with a verifiable timestamp. The computer-readable medium may include at least one instruction for causing the computer device to provide a copy of the ledger to plurality of other devices in communication with the computer device, wherein the plurality of other devices each have replicated state machines. The computer-readable medium may include at least one instruction for causing the computer device to receive copies of a plurality of other ledgers with other transactions associated with verifiable timestamps from each of the replicated state machines of the plurality of other devices, wherein the plurality of other ledgers corresponds to a number of the plurality of other devices. The computer-readable medium may include at least one instruction for causing the computer device to generate an ordered ledger with an ordered list of transactions by performing a total order process that uses the verifiable timestamps of the transactions from the ledger and the verifiable timestamps of the other transactions from the copies of the plurality of other ledgers. The computer-readable medium may include at least one instruction for causing the computer device to execute the ordered list of transactions from the ordered ledger.

Additional advantages and novel features relating to implementations of the present disclosure will be set forth in part in the description that follows, and in part will become more apparent to those skilled in the art upon examination of the following or upon learning by practice thereof.

### DESCRIPTION OF THE FIGURES

In the drawings:

FIG. 1 is a schematic block diagram of a system with a set of distributed nodes in accordance with an implementation of the present disclosure;

FIG. 2 is an example of a ledger in accordance with an implementation of the present disclosure;

FIG. 3 is a schematic block diagram of a set of distributed nodes in accordance with an implementation of the present disclosure;

FIG. 4 is an example method flow for a verifiable timestamping process in accordance with an implementation of the present disclosure;

FIG. 5 is an example method flow for a consensus process in accordance with an implementation of the present disclosure;

FIG. 6 is an example method flow for a total ordering process in accordance with an implementation of the present disclosure;

FIG. 7 is an example method flow for creating a totally ordered ledger of transaction in accordance with an implementation of the present disclosure; and

FIG. 8 is a schematic block diagram of an example device in accordance with an implementation of the present disclosure.

### DETAILED DESCRIPTION

This disclosure relates to devices and methods for nodes in a distributed system to agree on a totally ordered ledger of transactions. For example, the nodes may be a set of mutually-distrusting organizations that maintain a shared, append-only ledger. The devices and methods provide a decentralized Byzantine consensus protocol without a special leader node to propose an ordering of transactions and/or a pre-defined sequence of consensus instances. Byzantine consensus is a distributed protocol for n nodes to reach agreement on a single value proposed by a node even if up to f of the n nodes could experience Byzantine faults and deviate arbitrarily from their prescribed protocol. A value is eventually committed as the chosen value. Once a value is chosen, each non-faulty node can learn the value and the chosen value will never change

The devices and methods may create multiple instances of a replicated state machine (RSM) where each node is a leader in a separate instance. In an RSM, each non-faulty node starts with the same initial state, agrees on a sequence of transactions that mutate the state deterministically, and therefore maintains a consistent state after each transaction. A consortium blockchain, for example, can be regarded as n mutually distrusting nodes implementing an RSM to maintain a consistent, append-only ledger of transactions (despite at most f Byzantine faults out of n nodes).

The devices and methods may provide a transaction submission for new proposals. Proposals committed in each instance of an RSM are first timestamped in a decentralized manner by a quorum of nodes. Nodes then derive a total ordering of transactions committed across different RSM instances using a total ordering process that each node runs locally.

Each node is a preferred leader of its own instance of a Byzantine fault-tolerant replicated state machine (RSM) maintaining a separate append-only ledger. Such a design restores symmetry in the consensus protocol for fairness while also removing the leader-introduced bottleneck by allowing concurrency among different RSMs that can proceed independently. A faulty node might temporarily affect the progress of an RSM instance for which it is a leader, but it cannot affect other RSM instances.

Unlike traditional Byzantine consensus protocols where a global total ordering is coupled with agreement in a sequence of consensus instances, the devices and methods decouples global total ordering from agreement. Specifically, the devices and methods may use a verifiable timestamping protocol to form a consistent, global total ordering of proposals across different RSM instances. To propose a transaction, a proposer (or a leader) executes a verifiable timestamping protocol where the leader gathers digitally signed timestamps from a quorum of nodes. The transaction is then verifiably timestamped with the medium value of those timestamps. The timestamped transaction is then submitted as a proposal to one of the RSM instances to perform a consensus process to reach agreement. Nodes then run a total ordering process locally on ledgers constructed in different RSM instances to derive a consistent total ordering of transactions.

By providing a decentralized Byzantine consensus protocol without a special leader node to propose an ordering of transactions, no single node can influence the total order and more parallelism may be created. In addition, the devices and methods may and offer more scalability and may increase a number of transactions per second with minimal latencies.

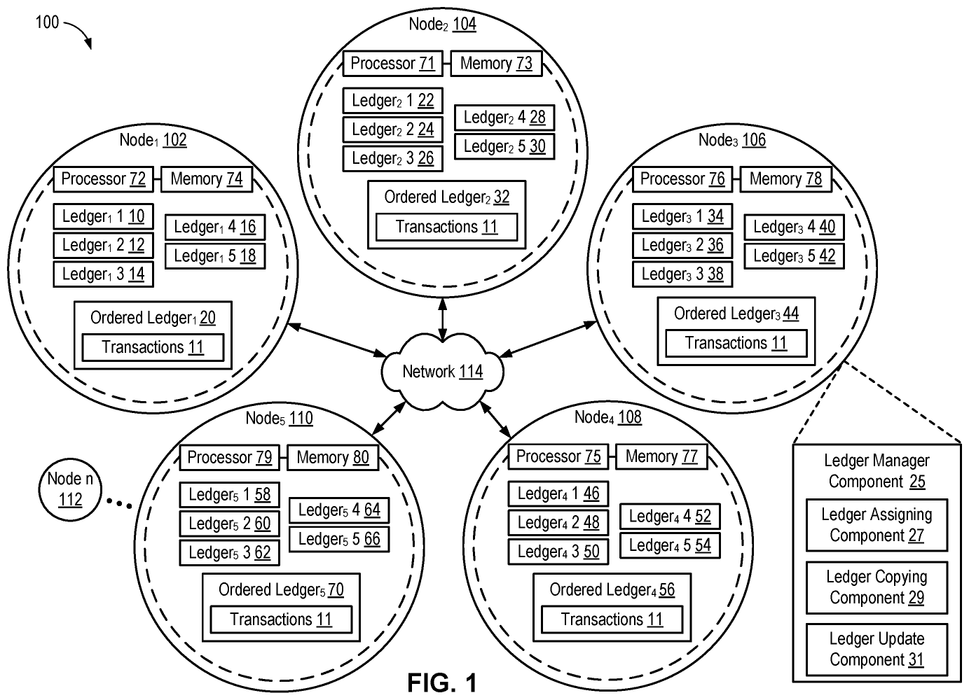

Referring now to FIGS. 1-3, a system 100 for use with creating ordered ledgers 20, 32, 44, 56, 70 of transactions 11 for use with system 100. System 100 may include a collection of nodes 102, 104, 106, 108, 110 up ton nodes 112 (where n is an integer), where each node 102, 104, 106, 108, 110 participates in a distributed protocol. For example, nodes 102, 104, 106, 108, 110 may communication with each other via a wired or wireless network 114.

Nodes 102, 104, 106, 108, 110 may include any mobile or fixed computer device, which may be connectable to a network. Nodes 104, 106, 108, 110 may be, for example, a computer device such as a desktop or laptop or tablet computer, an internet of things (IOT) device, a cellular telephone, a gaming device, a mixed reality or virtual reality device, a music device, a television, a navigation system, a camera, a personal digital assistant (PDA), or a handheld device, or any other computer device having wired and/or wireless connection capability with one or more other devices.

Nodes 102, 104, 106, 108, 110 may include processors 71, 72, 75, 76, 79 and/or memories 73, 74, 77, 78, 80. Memories 73, 74, 77, 78, 80 of nodes 102, 104, 106, 108, 110 may be configured for storing data and/or computer-executable instructions defining and/or associated with nodes 102, 104, 106, 108, 110, and processors 71, 72, 75, 76, 79 may execute such data and/or instructions to instantiate operations on nodes 102, 104, 106, 108, 110. An example of memories 73, 74, 77, 78, 80 can include, but is not limited to, a type of memory usable by a computer, such as random access memory (RAM), read only memory (ROM), tapes, magnetic discs, optical discs, volatile memory, non-volatile memory, and any combination thereof. An example of processor 54 can include, but is not limited to, any processor specially programmed as described herein, including a controller, microcontroller, application specific integrated circuit (ASIC), field programmable gate array (FPGA), system on chip (SoC), or other programmable logic or state machine.

Each node 102, 104, 106, 108, 110 in system 100 may be associated with a ledger 10, 24, 38, 52, 66 that records one or more transactions 11 for system 100. Transactions 11 may include any application-specific events recorded in a tamper-resistant manner. Example transactions 11 may include, but are not limited to, financial transactions, business transactions, and/or a description of an event (e.g., a user accessing a sensitive file) that may be recorded on a distributed ledger.

Each node 102, 104, 106, 108, 110 may include a ledger manager component 25 that manages the ledgers and copies of ledgers on nodes 102, 104, 106, 108, 110. Ledger manager component 25 may include a ledger assigning component 27 that assigns and/or associates a ledger 10, 24, 38, 52, 66 to each node 102, 104, 106, 108, 110.

For example, node₁ 102 may be associated with ledger₁ 1 (10) and node₁ 102 may be identified as a leader for ledger₁ 1 (10). As such, node₁ 102 may be able to write to ledger₁ 1 (10) by adding and/or removing transactions 11 from ledger₁ 1 (10). Node₂ 104 may be associated with ledger₂ 2 (24) and may be identified as a leader for ledger₂ 2 (24). Node₃ 106 may be associated with ledger₃ 3 (38) and may be identified as a leader for ledger₃ 3 (38). Node₄ 108 may be associated with ledger₄ 4 (52) and may be identified as a leader for ledger₄ 4 (52). Nodes 110 may be associated with ledgers 5 (66) and may be identified as a leader for ledgers 5 (66). As such, each node 102, 104, 106, 108, 110 may be a leader for a particular ledger so that only one node 102, 104, 106, 108, 110 may write to each of the ledgers. The remaining nodes 102, 104, 106, 108, 110 may maintain copies of all the ledgers associated with each node 102, 104, 106, 108, 110 as transactions 11 are added to the ledgers.

Ledger manager component 25 may include a ledger copying component 29 that provides copies of the ledgers associated with each node 102, 104, 106, 108, 110 to all of the nodes 102, 104, 106, 108, 110 in system 100. For example, node₁ 102 may have copies of ledger₁ 1 (10), ledger₁ 2 (12), ledger₁ 3 (14), ledger₁ 4 (16), and ledger₁ 5 (18). Node₂ 104 may have copies of ledger₂ 1 (22), ledger₂ 2 (24), ledger₂ 3 (26), ledger₂ 4 (28), and ledger₂ 5 (30). Node₃ 106 may have copies of ledger₃ 1 (34), ledger₃ 2 (36), ledger₃ 3 (38), ledger₃ 4 (40), and ledger₃ 5 (42). Node₄ 108 may have copies of ledger₄ 1 (46), ledger₄ 2 (48), ledger₄ 3 (50), ledger₄ 4 (52) and ledger₄ 5 (54). Nodes 110 may have copies of ledgers 1 (58), ledgers 2 (60), ledgers 3 (62), ledgers 4 (64) and ledgers 5 (66). As such, each node 102, 104, 106, 108, 110 may maintain n ledgers corresponding to the total number of nodes 102, 104, 108, 110 in system 100, where each ledger may maintain a partial order of transactions 11.

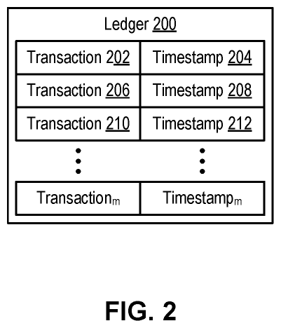

Referring now to FIG. 2, illustrated is an example ledger 200 for use with system 100. Ledger 200 may be any one of the ledgers discussed in FIG. 1. For example, ledger 200 may include a plurality of transactions 202, 206, 210 up to m transactions (where m is an integer). Transactions 202, 206, 210 may correspond to transactions 11 (FIG. 1) Each transaction 202, 206, 210 may be associated with a timestamp 204, 208, 212. For example, transaction 202 may be associated with timestamp 204; transaction 206 may be associated with timestamp 208; and transaction 210 may be associated with timestamp 212. Timestamps 204, 208, 212 may increase monotonically in value. For example, timestamp 204 may be an earlier time relative to timestamps 208, 212. In addition, timestamp 212 may be a later time relative to timestamps 204, 208. As such, transactions 202, 206, 210 may be placed in an order in ledger 200 using the timestamps 204, 208, 212.

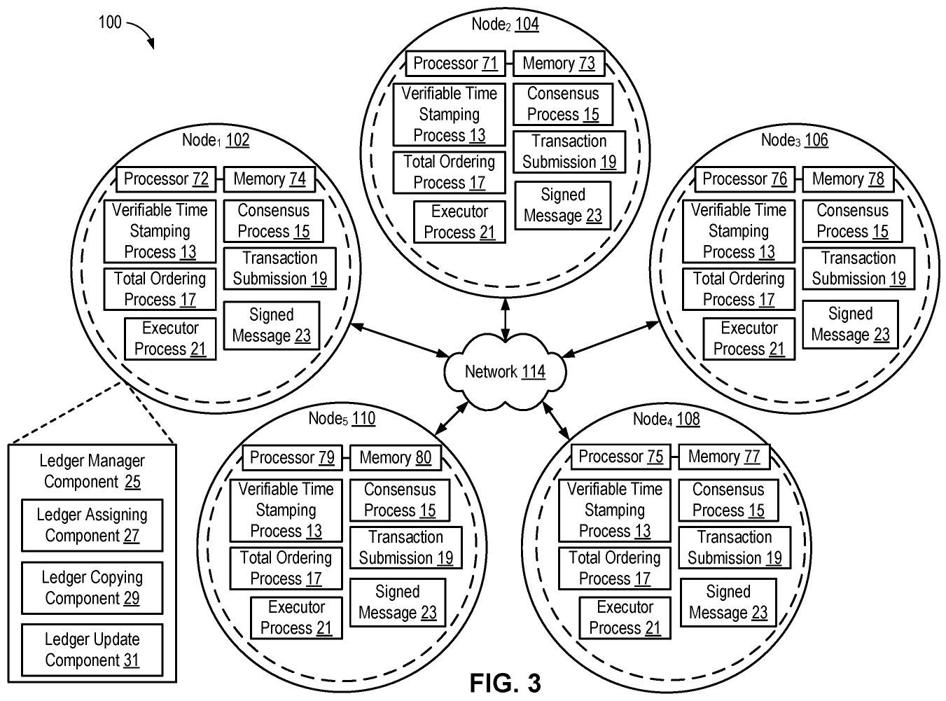

Referring to FIG. 3, when a node 102, 104, 106, 108, 110 wants to add a transaction 11 (see FIG. 1) to any one of ledgers 10, 24, 38, 52, 66, ledger manager component 25 may send a transaction submission request 19 with the new transaction 11. In addition, ledger manager component 25 may request a verifiable timestamping process 13 to occur on the new transaction 11. A verifiable timestamping process 13 may use any timestamping protocol that may request a timestamp for the transaction 11.

The verifiable timestamping process 13 may generate a global ordering for transactions 11 rather than imposing a pre-determined, totally ordered sequence of consensus instances. Every node 102, 104, 106, 108, 110 may maintain a local counter that is strictly monotonically increasing. In addition, each node 102, 104, 106, 108, 110 may have a unique private key to digitally sign messages, and that each node 102, 104, 106, 108, 110 may know the public keys of other nodes 102, 104, 106, 108, 110 so that each node 102, 104, 106, 108, 110 can locally verify signatures on messages received from other nodes 102, 104, 106, 108, 110.

For example, if node 102 submits a transaction submission request 19 to add a new transaction 11 to ledger₁ 1 (10), node 102 may perform the verifiable timestamping process 13. Node 102 may send a transaction submission request 19 to the remaining nodes 104, 106, 108, 110. Nodes 104, 106, 108, 110 may respond to the transaction submission request 19 with a signed message 23. The signed message 23 may include a hash of the transaction, a timestamp for the transaction, and/or a digital signature of the node.

The verifiable timestamping process 13 may require a supermajority of the nodes 102, 104, 106, 108, 110 to provide a timestamp for the transaction 11. Ledger manager component 25 may send a signed message 23 with the timestamp for the transaction 11. For example, a supermajority of the nodes for this example may be two thirds of the nodes (e.g., three nodes). The verifiable timestamping process 13 may take a medium timestamp of all the timestamps received in the signed messages 23 for the transaction 11 and may assign the medium timestamp as the timestamp for the transaction 11.

Once a timestamp is assigned for the transaction 11, ledger manager component 25 may request a consensus process 15 be performed on the new transaction 11. For example, node 102 may request a consensus process 15 be performed on the new transaction 11. The consensus process 15 may use any leader based multi round consensus protocol that occurs on the timestamp transactions to verify the new transaction 11.

Once the new transaction 11 is verified, ledger manager component 25 may include an ledger update component 31 that adds the new transaction 11 to the ledger associated with the node that submitted the transaction submission request 19. For example, if node 102 submitted the transaction submission request 19, the new transaction 11 will be added to ledger₁ 1 (10). The respective copies of ledger₁ 1 (10) (e.g., ledger₂ 1 (22), ledger₃ 1 (34), ledger₄ 1 (46), ledgers 1 (58)) may also be updated to reflect the addition of the new transaction 11 to ledger₁ 1 (10).

As new transactions 11 are added to the ledgers associated with the node that submitted the transaction submission request 19, the ledger update component 31 may provide each node 102, 104, 106, 108, 110 with updated copies of the ledgers with the new transaction 11 and the associated timestamp. As such, each node 102, 104, 106, 108, 110 may have the same transactions 11 and associated timestamps recorded on the ledgers.

Each node 102, 104, 106, 108, 110 may also maintain an ordered ledger 20, 32, 44, 56, 70 in addition to the n ledgers mentioned above. The ordered ledgers 20, 32, 44, 56, 70 may be created by performing a total ordering process 17. Ledger manger component 25 may perform the total ordering process 17 on then ledgers maintained by the nodes 102, 104, 106, 108, 110. The total ordering process 17 may merge the n ledgers maintained by each node 102, 104, 106, 108, 110 to result in a complete ordered ledger 20, 32, 44, 56, 70 with a list of the transactions 11 for system 100. The entries of transactions 11 on the ordered ledgers 20, 32, 44, 56, 70 may be sorted by the timestamps associated with the entries.

Each node 102, 104, 106, 108, 110 may periodically append entries to the ordered ledgers 20, 32, 44, 56, 70 from each of the n ledgers by performing the total ordering process 17. As such, each node 102, 104, 106, 108, 110 may have a different copies of the ordered ledgers 20, 32, 44, 56, 70.

Each node 102, 104, 106, 108, 110 may execute the transactions 11 on the ordered ledgers 20, 32, 44, 56, 70 at different times. For example, ledger manager component 25 may perform an executor process 21 to execute the transactions 11 locally from the ordered ledgers 20, 32, 44, 56, 70.

By using the timestamps to order the transactions 11 in the ordered ledgers 20, 32, 44, 56, 70, all the nodes 102, 104, 106, 108, 110 may agree on the same total order of transactions 11 even though the nodes 102, 104, 106, 108, 110 may add the transactions 11 to the ordered ledgers 20, 32, 44, 56, 70 at different times and/or may execute the transactions 11 of the ordered ledgers 20, 32, 44, 56, 70 locally at different times. As such, the ordered ledgers 20, 32, 44, 56, 72 may achieve the same order of transactions 11 regardless of when each nodes 102, 104, 106, 108, 110 merges the transactions 11 to the ordered ledgers 20, 32, 44, 56, 70.

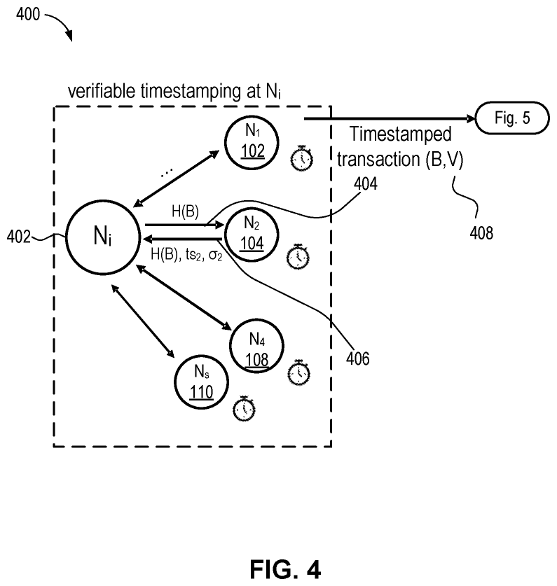

Referring now to FIG. 4, an example method flow 400 for a verifiable timestamping process 13 (FIG. 3) that may be performed by any one of nodes 102, 104, 106, 108, 110 (FIG. 3). The actions of method 400 may be discussed below with reference to the architecture of FIGS. 1-3.

At 404, method 400 may include sending a transaction submission for a new transaction. A leader 402, e.g., node 106, may send a transaction submission request 19 with a proposal for a new transaction 11 to nodes 102, 104, 108, 110. The transaction submission request 19 may request signed messages with a timestamp from a quorum of nodes (e.g., a supermajority of nodes 102, 104, 108, 110), where a responding node signs the proposal, along with the current value of the local counter. The construction can be easily generalized to other forms of quorums where there must exist at least one non-faulty node in the intersection of any pair of quorums and that there always exists a quorum consisting of only non-faulty nodes.

Every node 102, 104, 106, 108, 110 may maintain a local counter that is strictly monotonically increasing. In addition, each node 102, 104, 106, 108, 110 may have a unique private key to digitally sign messages, and that each node 102, 104, 106, 108, 110 may know the public keys of other nodes 102, 104, 106, 108, 110 so that each node 102, 104, 106, 108, 110 can locally verify signatures on messages received from other nodes 102, 104, 106, 108, 110.

By using the verifiable timestamping process 13, each proposal submitted with a transaction submission request 19 may carry a timestamp assigned in a decentralized manner. Furthermore, an assigned timestamp is verifiable so that any node 102, 104, 106, 108, 110 in the system can verify that the timestamp associated with a proposal is indeed assigned in a decentralized manner. To facilitate this, each node 102, 104, 106, 108, 110 maintains a monotonically increasing counter, such that, for any number x (where x is an integers), the counter value eventually exceeds x.

For example, when a node Ni, e.g., leader 402, wishes to create a proposal for a transaction tx, leader 402 broadcasts H(tx), where HO is a cryptographic hash function, to other nodes and waits for responses. A correct node, say Nj (e.g., node 102), responds with a signed timestamp, which is a message of the following form: (H(tx), tsj, σᵢ) where tsj is Nj's local counter and σⱼ is a digital signature on the message (H(tx), tsj). A correct node never responds with a different timestamp to the same request.

After receiving responses from a quorum of nodes, Node Ni (e.g., leader 402) constructs a timestamped transaction, which is a message of the form: (tx, V), where V is an ordered list of signed timestamps for tx from 2f+1 nodes (a quorum of nodes). For efficiency, leader 402 may create timestamped batches where each batch contains an ordered sequence of transactions 11.

At 406, method 400 may include receiving the signed messages from one or more nodes. The leader 402, e.g., node 106, may receive one or more signed messages from one or more nodes 102, 104, 108, 110. The signed messages may include, for example, a hash of the transaction, a timestamp, and a digital signature of the node 102, 104, 108, 110.

At 408, method 400 may include assigning a median value of the timestamps received as the global timestamp for the new transaction 11. For example, the leader 402 (e.g., node 106), may assigns a median value of the counter values from the timestamps received in the signed messages as the global timestamp for the new transaction 11 and may construct a verifiable timestamp for the new transaction 11. The assigned timestamp may be derived from the local counters from the supermajority of nodes 102, 104, 108, 110 and, given the median value. Moreover, the assigned timestamp is guaranteed to be bounded by counters from non-faulty nodes because only up to f (out of n) nodes can be faulty.

A timestamped transaction (B, V) may be valid if the following conditions are met: V contains a supermajority of signed timestamps for B; each signed timestamp in V is from a distinct node; and each signed timestamp in V has a valid signature.

As such, the verifiable timestamping process 13 may generate a global ordering for transactions 11 rather than imposing a pre-determined, totally ordered sequence of consensus instances.

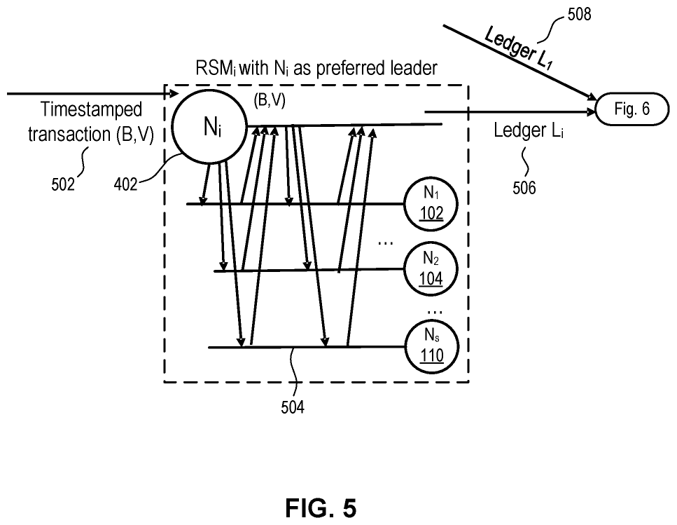

Referring now to FIG. 5, a method 500 for a consensus process 15 (FIG. 3) that may be performed by any one of nodes 102, 104, 106, 108, 110 (FIG. 3). The actions of method 500 may be discussed below with reference to the architecture of FIGS. 1-3.

A leader 402, e.g., node 106, may generate a timestamped transaction 502, as discussed above in FIG. 4. At 504, method 500 may include performing a consensus process on the timestamped transaction 502. For example, the leader 402 may request nodes 102, 104, 108, 110 to perform a multiple round consensus process 15 to verify the timestamped transaction 502.

For example, a sub-RSM for leader 402 is a standard RSM that tolerates Byzantine faults, but with leader 402 as its preferred leader. In the normal case, leader 402 may act as the leader carrying out the consensus process 15. The additional power associated with a leader to decide what to propose and in what order is constrained within a sub-RSM: leader 402 cannot influence what gets proposed on sub-RSMs where leader 402 is not the leader and cannot dictate the global order on proposals in other sub-RSMs due to a decentralized ordering.

A new leader may be needed for progress when the preferred leader fails. For example, if leader 402 fails, a new leader may be selected. Even in this case, all the sub-RSMs with a different, non-faulty leader continue to have new proposals committed. The lack of progress in one sub-RSM during leader changes affects only when a new committed proposal's global order is known, which requires knowing all the proposals that could be committed in any sub-RSM with a lower timestamp.

For example a leader election for a new leader, may include the following properties: (i) the preferred leader remains in the leadership role as long as it can make progress in a timely fashion (e.g., timely communicate with a supermajority of nodes); (ii) the preferred leader takes over the leadership role as soon as the preferred leader can make timely progress again; (iii) a Byzantine faulty preferred leader would not be able to use its preferred status to cause infinite leader changes without real progress—for example, the preferred leader, being malicious, could take over the leadership role after a non-faulty node becomes a new leader, but before the non-faulty leader makes any real progress in getting new proposals committed.

Each sub-RSM executes independently and commits proposals without knowing the exact position of those proposals in the global total order. The impact of a faulty leader in any sub-RSM is significantly limited: other sub-RSM with a different leader can continue making progress and commit new proposals. No single leader dictates the global total order. Before executing a committed proposal with a timestamp t, a node leader 402 must wait until every sub-RSM's sequence of committed proposals (in the monotonically increasing timestamping order) reaches one with a timestamp that is at least t. This ensures that leader 402 has learned all committed proposals with a timestamp lower than t.

Nodes in each RSM instance require the proposer to propose valid timestamped transactions with monotonically-increasing timestamp values. More formally, RSMi reaches consensus on an append-only ledger Li where: (1) each entry in Li is a valid timestamped transaction; and (2) timestamp(Li[j])<timestamp(Li[k]) for all j, k such that j<k and j, k□{0, . . . , len(Li)}.

As such, the consensus process 15 generates a plurality of ledgers 506, 508 with timestamped transactions approved by the nodes 102, 104, 106, 108, 110 in system 100.

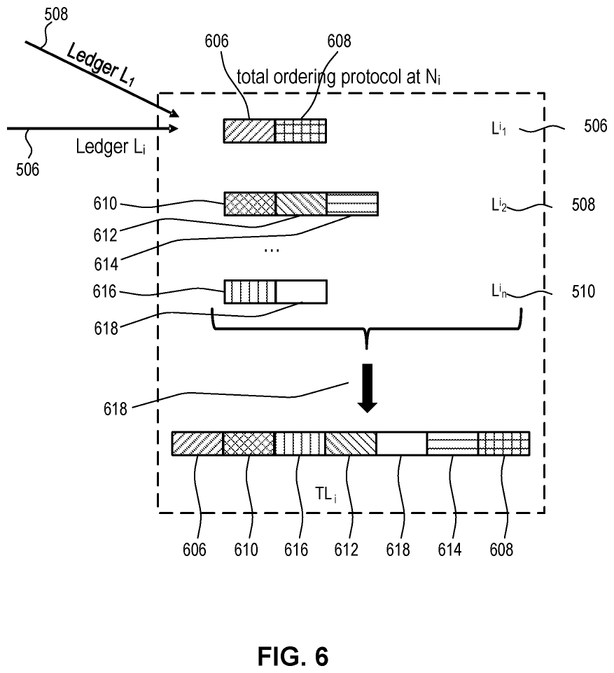

Referring now to FIG. 6, a method 600 for a total ordering process 17 (FIG. 3) of a plurality of ledgers 506, 508, 510 that may be performed by any one of nodes 102, 104, 106, 108, 110 (FIG. 3). The actions of method 600 may be discussed below with reference to the architecture of FIGS. 1-3.

Ledger 506 may include two transactions 606, 608; ledger 508 may include three transactions 610, 612, 614; and ledger 510 may include two transactions 616, 618. Each transaction 606, 608, 610, 612, 614, 616, and 618 may be associated with a timestamp.

At 618, method 600 may include performing a total ordering process. Each one of nodes 102, 104, 106, 108, 110 may perform the total ordering process 17. The total ordering process 17 may merge ledgers 506, 508, and 510 into a single ordered ledger 20, 32, 44, 56, 70 with transactions 606, 608, 610, 612, 614, 616, 618 ordered by the associated timestamps. For example, the ordered ledger 20, 32, 44, 56, 70 may include the following order transaction 606, transaction 610, transaction 616, transaction 612, transaction 618, transaction 614, and transaction 608, where the associated timestamps increase for each transaction.

Each node 102, 104, 106, 108, 110 has a copy of n ledgers, one from each RSM instance. For example, node Ni (0<i<n) has L_0\hat{ }i, . . . , L_(n−1)\hat{ }i where each ledger is a totally-ordered sequence of valid timestamped transactions. The below example method may allow Ni to derive a total ordering of transactions as desired for the ordered ledger 20, 32, 44, 56, 70. The description below generalizes to a version where nodes incrementally compute a total ordering of transactions.

Input: n ledgers L₀ⁱ, . . . , Lₙⁱ−1

Where Mi is a vector of n timestamps where the jth entry holds the maximum timestamp of a timestamped transaction in ledger Lⁱⱼ.

Where Sⁱ is a set of timestamped transactions in L₀ⁱ, . . . , Lₙⁱ−1 such that the timestamp of any timestamped transaction ≤min(Mⁱ).

Where Lⁱ is an ordered sequence of timestamped transactions in g sorted by their timestamps and with ties broken by the hash of the transaction.

Output: A ledger Lⁱ

Each of the n ledgers is append-only. As such, any timestamped transaction added to any of the n ledgers in the future will have a timestamp that is more than min (Mi), where Mi is as described above in the ordering procedure. Since Li only contains times-tamped transactions with timestamps that are <min(Mi), no future transaction appended to any of the n ledgers will be ordered before any timestamped transaction in Li.

As such, as new transactions 11 are added to system 100, the total ordering process 17 may ensure that the new transactions 11 are placed in a correct order relative to the other transactions in the ordered ledgers 20, 32, 44, 56, and 70.

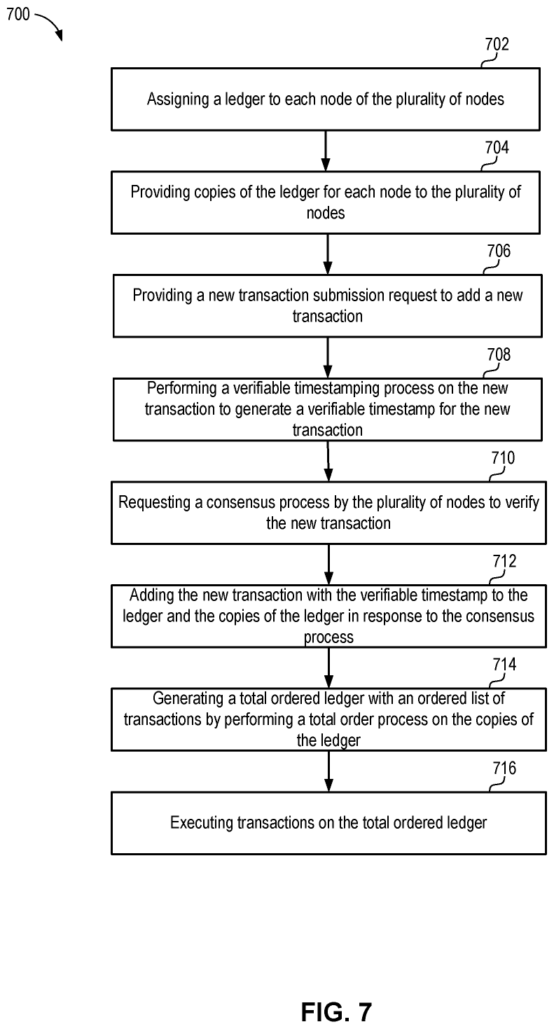

Referring now to FIG. 7, method 700 for creating a totally ordered ledger of transaction that may be performed by any one of nodes 102, 104, 106, 108, 110 (FIG. 7). The actions of method 700 may be discussed below with reference to the architecture of FIGS. 1-3. Method 700 may create multiple instances of a replicated state machine (RSM) where each node 102, 104, 106, 108, 110 is a leader in a separate instance. Each node 102, 104, 106, 108, 110 may include a processor 71, 72, 75, 76, 79 executing instructions to perform the actions of method 700 and/or a memory 73, 74, 77, 78, 80 for storing the instructions of method 700. Each node 102, 104, 106, 108, 110 may include a ledger manager component 25 that manages the ledgers and copies of ledgers on nodes 102, 104, 106, 108, 110. For example, ledger manager component 25 may perform the actions of method 700 and may be executed by processor 71, 72, 75, 76, 79. In addition, ledger manager component 25 may obtain memory resources 73, 74, 77, 78, 80 and may reserve the memory resources for storing the instructions of method 700.

At 702, method 700 may include assigning a ledger to each node of the plurality of nodes. System 100 may include a collection of nodes 102, 104, 106, 108, 110 up ton nodes 112 (where n is an integer), where each node 102, 104, 106, 108, 110 participates in a distributed protocol. Each node 102, 104, 106, 108, 110 in system 100 may be associated with a ledger 10, 24, 38, 52, 66 that records one or more transactions 11 for system 100. Transactions 11 may include any application-specific events recorded in a tamper-resistant manner. Example transactions 11 may include, but are not limited to, financial transactions, business transactions, and/or a description of an event (e.g., a user accessing a sensitive file) that may be recorded on a distributed ledger. Ledger manager component 25 may include a ledger assigning component 27 that assigns and/or associates a ledger 10, 24, 38, 52, 66 to each node 102, 104, 106, 108, 110.

For example, node₁ 102 may be associated with ledger₁ 1 (10) and node₁ 102 may be identified as a leader for ledger₁ 1 (10). As such, node₁ 102 may be able to write to ledger₁ 1 (10) by adding and/or removing transactions 11 from ledger₁ 1 (10). Node₂ 104 may be associated with ledger₂ 2 (24) and may be identified as a leader for ledger₂ 2 (24). Node₃ 106 may be associated with ledger₃ 3 (38) and may be identified as a leader for ledger₃ 3 (38). Node₄ 108 may be associated with ledger₄ 4 (52) and may be identified as a leader for ledger₄ 4 (52). Nodes 110 may be associated with ledgers 5 (66) and may be identified as a leader for ledgers 5 (66). As such, each node 102, 104, 106, 108, 110 may be a leader for a particular ledger so that only one node 102, 104, 106, 108, 110 may write to each of the ledgers.

At 704, method 700 may include providing copies of the ledger for each node to the plurality of nodes. Ledger manager component 25 may include a ledger copying component 29 that provides copies of the ledgers associated with each node 102, 104, 106, 108, 110 to all of the nodes 102, 104, 106, 108, 110 in system 100. Nodes 102, 104, 106, 108, 110 may maintain copies of all the ledgers associated with each node 102, 104, 106, 108, 110 as transactions 11 are added to the ledgers. As such, each node 102, 104, 106, 108, 110 may maintain n ledgers corresponding to the total number of nodes 102, 104, 108, 110 in system 100, where each ledger may maintain a partial order of transactions 11.

At 706, method 700 may include providing a new transactions submission request to add a new transaction. For example, ledger manager component 25 may send a transaction submission request 19 with a proposal for a new transaction 11. A leader, e.g., node 106, may send a transaction submission request 19 with a proposal for a new transaction 11 to nodes 102, 104, 108, 110. The transaction submission request 19 may request signed messages with a timestamp from a quorum of nodes (e.g., a supermajority of nodes 102, 104, 108, 110), where a responding node signs the proposal, along with the current value of the local counter. The construction can be easily generalized to other forms of quorums where there must exist at least one non-faulty node in the intersection of any pair of quorums and that there always exists a quorum consisting of only non-faulty nodes.

At 708, method 700 may include performing a verifiable timestamping process on the new transaction to generate a verifiable timestamp for the new transaction. For example, ledger manager component 25 may perform a verifiable timestamping process 13 on the new transaction 11. The verifiable timestamping process 13 may generate a global ordering for transactions 11 rather than imposing a pre-determined, totally ordered sequence of consensus instances. Every node 102, 104, 106, 108, 110 may maintain a local counter that is strictly monotonically increasing. In addition, each node 102, 104, 106, 108, 110 may have a unique private key to digitally sign messages, and that each node 102, 104, 106, 108, 110 may know the public keys of other nodes 102, 104, 106, 108, 110 so that each node 102, 104, 106, 108, 110 can locally verify signatures on messages received from other nodes 102, 104, 106, 108, 110.

The verifiable timestamping process 13 may require a supermajority of the nodes 102, 104, 106, 108, 110 to provide a timestamp for the transaction 11. Ledger manager component 25 may sent a signed message 23 with a timestamp for the transaction 11. For example, a supermajority of the nodes for this example may be two thirds of the nodes (e.g., three nodes) may need to provide signed messages 23. The signed messages 23 may include a hash of the transaction, a timestamp for the transaction, and/or a digital signature of the node. The verifiable timestamping process 13 may take a medium timestamp of all the timestamps received in the signed messages 23 for the transaction 11 and may assign the medium timestamp as the verifiable timestamp for the transaction 11.

At 710, method 700 may include requesting a consensus process by the plurality of nodes to verify the new transaction. For example, ledger manager component 25 may request a consensus process 15 on the new transaction 11. Once a verifiable timestamp is assigned for the transaction 11, ledger manager component 25 may request a consensus process 15 on the new transaction 11. For example, node 102 may request a consensus process 15 be performed on the new transaction 11. The consensus process 15 may use any leader based multi round consensus protocol that occurs on the verifiable timestamp transactions to verify the new transaction 11.

At 712, method 700 may include adding the new transaction with the verifiable timestamp to the ledger and the copies of the ledger in response to the consensus process. Ledger manager component 25 may include a ledger update component 31 that may add and/or remove transactions 11 from the ledgers on a node 102, 104, 106, 108, 110. Ledger update component 31 may ensure that the transactions 11 remain consistent across nodes 102, 104, 106, 108, 110. Once the new transaction 11 is verified, the new transaction 11 may be added to the ledger associated with the node that submitted the transaction submission request 19. For example, if node 102 submitted the transaction submission request 19, the new transaction 11 will be added to ledger₁ 1 (10). The respective copies of ledger₁ 1 (10) (e.g., ledger₂ 1 (22), ledger₃ 1 (34), ledger₄ 1 (46), ledgers 1 (58)) may also be updated to reflect the addition of the new transaction 11 to ledger₁ 1 (10).

As new transactions 11 are added to the ledgers associated with the node that submitted the transaction submission request 19, each node 102, 104, 106, 108, 110 may receive updated copies of the ledgers with the new transaction 11 and the associated timestamp. As such, each node 102, 104, 106, 108, 110 may have the same transactions 11 and associated timestamps recorded on the ledgers.

At 714, method 700 may include generating a total ordered ledger with an ordered list of transactions by performing a total order process on the copies of the ledger. Ledger manager component 25 may perform a total ordering process 17 to generate an ordered ledger 20, 32, 44, 56, 70 of transactions 11. Each node 102, 104, 106, 108, 110 may maintain an ordered ledger 20, 32, 44, 56, 70 in addition to the n ledgers mentioned above. The ordered ledgers 20, 32, 44, 56, 70 may be created by performing a total ordering process 17. The total ordering process 17 may merge the n ledgers maintained by each node 102, 104, 106, 108, 110 to result in a complete ordered ledger 20, 32, 44, 56, 70 with a list of the transactions 11 for system 100. The entries of transactions 11 on the ordered ledgers 20, 32, 44, 56, 70 may be sorted by the verifiable timestamps associated with the entries.

Each node 102, 104, 106, 108, 110 may periodically append entries to the ordered ledgers 20, 32, 44, 56, 70 from each of the n ledgers by performing the total ordering process 17. As such, each node 102, 104, 106, 108, 110 may have a different copies of the ordered ledgers 20, 32, 44, 56, 70.

At 716, method 700 may include executing transactions on the total ordered ledger. Ledger manager component 25 may perform an executor process 21 that executes the transactions 11 in the ordered ledgers 20, 32, 44, 56, 70. Each node 102, 104, 106, 108, 110 may execute the transactions 11 in the ordered ledgers 20, 32, 44, 56, 70 at different times. For example, nodes 102, 104, 106, 108, 110 may perform an executor process 21 to execute the transactions 11 locally from the ordered ledgers 20, 32, 44, 56, 70. One example of the executor process 21 to execute transactions 11 may include transferring assets from one account to another account. For example, in a consortium blockchain transferring assets may include transferring currency from one user or a business to another user or a business.

As such, method 700 may be used to implement an RSM that minimizes leader-induced vulnerabilities, thereby making method 700 particularly suitable for emerging applications such as consortium blockchains. Method 700 may decentralize an ordering mechanism that departs fundamentally from how proposals are ordered traditionally; i.e., in a pre-ordered sequence of consensus instances.

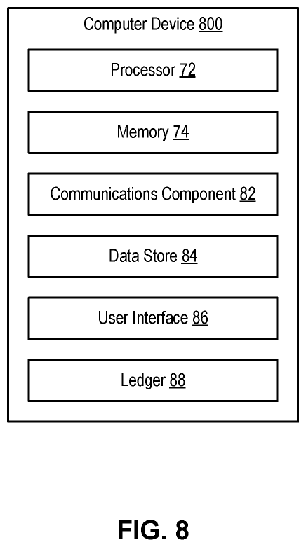

Referring now to FIG. 8 an example computer device 800 that may be configured as any one of nodes 102, 104, 106, 108, 110 in accordance with an implementation includes additional component details as compared to FIGS. 1-3. As an illustration, node 102 is used in the discussion of FIG. 8. In one example, computer device 800 may include processor 72 for carrying out processing functions associated with one or more of components and functions described herein. Processor 72 can include a single or multiple set of processors or multi-core processors. Moreover, processor 72 can be implemented as an integrated processing system and/or a distributed processing system.

Computer device 800 may further include memory 74, such as for storing local versions of applications being executed by processor 72. Memory 74 can include a type of memory usable by a computer, such as random access memory (RAM), read only memory (ROM), tapes, magnetic discs, optical discs, volatile memory, non-volatile memory, and any combination thereof. Additionally, processor 72 may include and execute an operating system on computer device 800.

Further, computer device 800 may include a communications component 82 that provides for establishing and maintaining communications with one or more parties utilizing hardware, software, and services as described herein. Communications component 82 may carry communications between components on node 102, as well as between node 102 and external devices, such as devices located across a communications network and/or devices serially or locally connected to node 102. For example, communications component 82 may include one or more buses, and may further include transmit chain components and receive chain components associated with a transmitter and receiver, respectively, operable for interfacing with external devices.

Additionally, computer device 800 may include a data store 84, which can be any suitable combination of hardware and/or software, that provides for mass storage of information, databases, and programs employed in connection with implementations described herein. For example, data store 84 may be a data repository for ledger 1 (10), ledger 2 (12), ledger 3 (14), ledger 4 (16), ledger 5 (18), and/or ordered ledger 20.

Computer device 800 may also include a user interface component 86 operable to receive inputs from a user of node 102 and further operable to generate outputs for presentation to the user. User interface component 86 may include one or more input devices, including but not limited to a keyboard, a number pad, a mouse, display (e.g., which may be a touch-sensitive display), a navigation key, a function key, a microphone, a voice recognition component, any other mechanism capable of receiving an input from a user, or any combination thereof. Further, user interface component 86 may include one or more output devices, including but not limited to a display, a speaker, a haptic feedback mechanism, a printer, any other mechanism capable of presenting an output to a user, or any combination thereof.

In an implementation, user interface component 86 may transmit and/or receive messages corresponding to the operation of ledger 1 (10), ledger 2 (12), ledger 3 (14), ledger 4 (16), ledger 5 (18), and/or ordered ledger 20. In addition, processor 72 executes ledger 1 (10), ledger 2 (12), ledger 3 (14), ledger 4 (16), ledger 5 (18), and/or ordered ledger 20, and memory 74 or data store 84 may store them.

As used in this application, the terms “component,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computer device and the computer device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Various implementations or features may have been presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative logics, logical blocks, and actions of methods described in connection with the embodiments disclosed herein may be implemented or performed with a specially-programmed one of a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computer devices, e.g., a combination of a DSP and a microprocessor, a plurality of microprocessors, one or more microprocessors in conjunction with a DSP core, or any other such configuration. Additionally, at least one processor may comprise one or more components operable to perform one or more of the steps and/or actions described above.

Further, the steps and/or actions of a method or algorithm described in connection with the implementations disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some implementations, the processor and the storage medium may reside in an ASIC. Additionally, the ASIC may reside in a user terminal. In the alternative, the processor and the storage medium may reside as discrete components in a user terminal. Additionally, in some implementations, the steps and/or actions of a method or algorithm may reside as one or any combination or set of codes and/or instructions on a machine readable medium and/or computer readable medium, which may be incorporated into a computer program product.

In one or more implementations, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

While implementations of the present disclosure have been described in connection with examples thereof, it will be understood by those skilled in the art that variations and modifications of the implementations described above may be made without departing from the scope hereof. Other implementations will be apparent to those skilled in the art from a consideration of the specification or from a practice in accordance with examples disclosed herein.

What is claimed is:

1. A device, comprising:
a memory to store data and instructions; and
at least one processor configured to communicate with the memory, wherein the at least one processor generates a replicated state machine on the device, wherein the replicated state machine is configured to:
assign a ledger to the device, wherein the ledger includes transactions associated with a verifiable timestamp;
provide a copy of the ledger to plurality of other devices in communication with the device, wherein the plurality of other devices each have replicated state machines;
receive copies of a plurality of other ledgers with other transactions associated with verifiable timestamps from each of the replicated state machines of the plurality of other devices, wherein the plurality of other ledgers corresponds to a number of the plurality of other devices;
generate an ordered ledger with an ordered list of transactions by performing a total order process that uses the verifiable timestamps of the transactions from the ledger and the verifiable timestamps of the other transactions from the copies of the plurality of other ledgers; and
execute the ordered list of transactions from the ordered ledger.

2. The device of claim 1, wherein the replicated state machine is further configured to:
provide a new transaction request to add a new transaction to the ledger;
perform a verifiable timestamping process on the new transaction;
request a consensus process performed by the plurality of other devices on the new transaction;
add the new transaction to the ledger in response to the consensus process; and
update the copy of the ledger on the plurality of other devices with the new transaction.

3. The device of claim 2, wherein the verifiable timestamping process further includes:
receiving a signed message from a supermajority of the plurality of other devices, wherein the signed message includes a time for the new transaction; and
setting a median of the time received from the supermajority of the plurality of other devices as the verifiable timestamp for the new transaction.

4. The device of claim 2, wherein the consensus process is a multiple round process performed by the plurality of other devices to verify the new transaction.

5. The device of claim 1, wherein the replicated state machine is further configured to perform the total order process periodically.

6. The device of claim 1, wherein the replicated state machine is further configured to:
assign the device as a leader for the ledger, wherein only the leader is allowed to add transactions to the ledger.

7. The device of claim 1, wherein the verifiable timestamps associated with the transactions increase monotonically.

8. The device of claim 1, wherein the copies of the plurality of other ledgers each include one ledger for each device of the plurality of other devices.

9. A method for creating a totally ordered ledger of transaction performed by a replicated state machine on a device with a memory and a processor, the method comprising:
assigning, by the replicated state machine, a ledger to the device, wherein the ledger includes transactions associated with a verifiable timestamp;
providing, via the replicated state machine, a copy of the ledger to plurality of other devices in communication with the device, wherein the plurality of other devices each have replicated state machines;
receiving copies of a plurality of other ledgers with other transactions associated with verifiable timestamps from each of the replicated state machines of the plurality of other devices, wherein the plurality of other ledgers corresponds to a number of the plurality of other devices;
generating, via the replicated state machine, an ordered ledger with an ordered list of transactions by performing a total order process that uses the verifiable timestamps of the transactions from the ledger and the verifiable timestamps of the other transactions from the copies of the plurality of other ledgers; and
executing, via the replicated state machine, the ordered list of transactions from the ordered ledger.

10. The method of claim 9, further comprising:
providing a new transaction request to add a new transaction to the ledger;
performing a verifiable timestamping process on the new transaction;
requesting a consensus process performed by the plurality of other devices on the new transaction;
adding the new transaction to the ledger in response to the consensus process; and
updating the copy of the ledger on the plurality of other devices with the new transaction.

11. The method of claim 10, wherein the verifiable timestamping process further includes:
receiving a signed message from a supermajority of the plurality of other devices, wherein the signed message includes a time for the new transaction; and
setting a median of the time received from the supermajority of the plurality of other devices as the verifiable timestamp for the new transaction.

12. The method of claim 10, wherein the consensus process is a multiple round process performed by the plurality of other devices to verify the new transaction.

13. The method of claim 9, wherein the total order process is performed periodically.

14. The method of claim 9, wherein the method further comprises:
assigning the device as a leader for the ledger, wherein only the leader is allowed to add transactions to the ledger.

15. The method of claim 9, wherein the verifiable timestamps associated with the transactions increase monotonically.

16. The method of claim 9, wherein the copies of the plurality of other ledgers each include one ledger for each device of the plurality of other devices.

17. A computer-readable medium storing instructions executable by a computer device, comprising:
at least one instruction for causing the computer device to assign a ledger to the computer device, wherein the computer device includes a replicated state machine and the ledger includes transactions associated with a verifiable timestamp;
at least one instruction for causing the computer device to provide a copy of the ledger to plurality of other devices in communication with the computer device, wherein the plurality of other devices each have replicated state machines;
at least one instruction for causing the computer device to receive copies of a plurality of other ledgers with other transactions associated with verifiable timestamps from each of the replicated state machines of the plurality of other devices, wherein the plurality of other ledgers corresponds to a number of the plurality of other devices;
at least one instruction for causing the computer device to generate an ordered ledger with an ordered list of transactions by performing a total order process that uses the verifiable timestamps of the transactions from the ledger and the verifiable timestamps of the other transactions from the copies of the plurality of other ledgers; and
at least one instruction for causing the computer device to execute the ordered list of transactions from the ordered ledger.

18. The computer-readable medium of claim 17, further comprising:
at least one instruction for causing the computer device to provide a new transaction request to add a new transaction to the ledger;
at least one instruction for causing the computer device to perform a verifiable timestamping process on the new transaction;
at least one instruction for causing the computer device to request a consensus process performed by the plurality of other devices on the new transaction;
at least one instruction for causing the computer device to add the new transaction to the ledger in response to the consensus process; and
at least one instruction for causing the computer device to update the copy of the ledger on the plurality of other devices with the new transaction.

19. The computer-readable medium of claim 18, wherein the verifiable timestamping process further includes:
at least one instruction for causing the computer device to receive a signed message from a supermajority of the plurality of other devices, wherein the signed message includes a time for the new transaction; and
at least one instruction for causing the computer device to set a median of the time received from the supermajority of the plurality of other devices as the verifiable timestamp for the new transaction.

20. The computer-readable medium of claim 18, wherein the consensus process is a multiple round process performed by the plurality of other devices to verify the new transaction.
